(19) United States
(12) Patent Application Publication
(10) Pub. No.: US 2008/0176025 A1
(43) Pub. Date: Jul. 24, 2008

(54) Composite wood and bamboo stick

(76) Inventor: Edward Xu, Shanghai (CN)

Correspondence Address: BIRCH STEWART KOLASCH & BIRCH, PO BOX 747, FALLS CHURCH, VA, 22040-0747, US

(21) Appl. No.: 11/655,850

(22) Filed: Jan. 22, 2007

(51) Int. Cl. B32B 5/12

(52) U.S. Cl. 428/106

(57) ABSTRACT

A composite wood and bamboo stick includes a core rod and a plurality of surface covers being pressed against and accordingly, tightly attached to outer sides of the core rod using a press, so as to form a complete stick. The core rod may be selected from the group consisting of a general wood material, a plywood material, and a composite wood material; and the surface covers may be selected from the group consisting of a general bamboo material, a bamboo plywood material, and a composite bamboo material. The composite wood and bamboo stick enables reduced consumption of wood, and the use of the bamboo surface covers gives the composite stick enhanced wear-resisting property.

### FIELD OF THE INVENTION

The present invention relates to a composite wood and bamboo stick, which includes a wood core rod and a plurality of bamboo surface covers attached to and around outer sides of the wood core rod, and is therefore a strong and tough stick.

### BACKGROUND OF THE INVENTION

There are various kinds cleaning and gardening tools used in daily life including one or more sticks, such as a broom stick connected to a broom head, a mop handle connected to a mop head, and handles connected to a pair of grass shears.

The sticks for most commercially available cleaning and gardening tools are made of wood or bamboo. While the wood stick is low-cost and therefore widely adopted by general consumers, it tends to become deformed and warped, and has low wear-resistance and accordingly, low reusability. Moreover, people have been warned about the gradually depleted wood resource in the world.

On the other hand, while there is a rich bamboo resource in the world and bamboo grows quickly, bamboo sticks require higher manufacturing cost than wood sticks. Moreover, bamboo is hollow and tends to break, heavy and not easily cut, and not convenient for grip.

It is therefore tried by the inventor to develop a composite wood and bamboo stick to overcome the disadvantages of wood and bamboo sticks while combining the advantages of wood and bamboo.

### SUMMARY OF THE INVENTION

A primary object of the present invention is to provide a composite wood and bamboo stick that has reduced manufacturing cost and increased strength, and is environment-friendly because it reduces the consumption of wood resource.

Another object of the present invention is to provide a composite wood and bamboo stick that uses bamboo material to replace part of wood material, and therefore has reduced weight than a pure wood stick and can be more easily and comfortably handled.

To achieve the above and other objects, the composite wood and bamboo stick according to a first embodiment of the present invention includes a wood core rod and a plurality of bamboo surface covers being firmly attached to and around outer sides of the wood core rod.

In a second embodiment of the present invention, the composite wood and bamboo stick includes a wood core rod being formed at an end with a first joint and at another opposite end with a second joint; a plurality of bamboo surface covers being firmly attached to and around outer sides of the wood core rod, such that an annular retaining space is formed between the first joint and the surface covers; a linking head being formed at two opposite ends with a male connector and a female connector, and the female end being tightly fitted around the second joint; and an end cap including a top and an annular ring portion axially protruded from an inner side of the top by a predetermined length for engaging with the annular retaining space.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a composite wood and bamboo stick according to a preferred embodiment of the present invention;

FIG. 2a shows a round-sectioned composite wood and bamboo stick of the present invention;

FIG. 2b shows a polygonal-sectioned composite wood and bamboo stick of the present invention;

FIG. 3 is an exploded perspective view showing another embodiment of the composite wood and bamboo stick of the present invention;

FIG. 4 is a radial section showing an annular retaining space is formed at an end of the composite wood and bamboo stick of FIG. 3;

FIG. 5a is an exploded longitudinally sectional view of the composite wood and bamboo stick of FIG. 3;

FIG. 5b is an assembled view of FIG. 5a;

FIG. 6a shows the composite wood and bamboo stick of FIG. 3 is used as a broomstick for connecting to a broom head;

FIG. 6b shows the composite wood and bamboo stick of FIG. 3 is used as a mop handle for connecting to a mop head; and

FIG. 6c shows the composite wood and bamboo stick of FIG. 3 is used as a handle for connecting to a pair of grass shear blades.

### DETAILED DESCRIPTION OF THE PREFERRED EMBODIMENTS

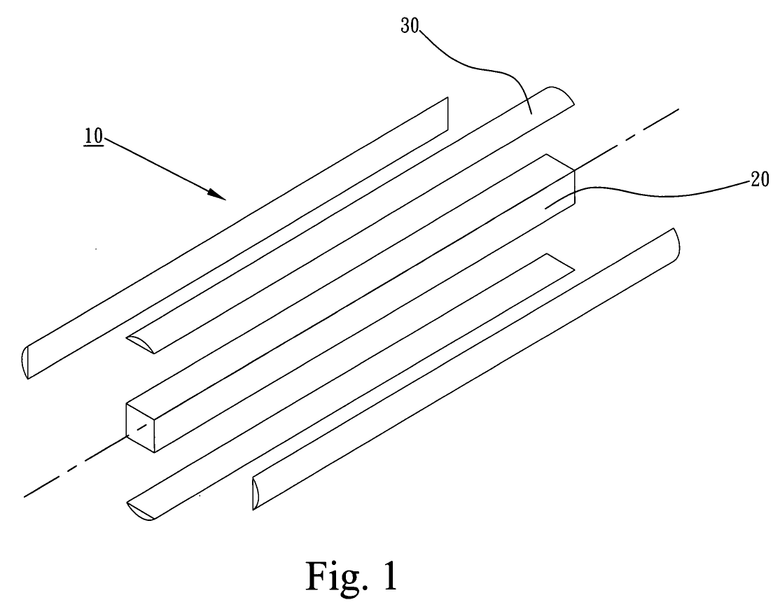

Please refer to FIG. 1 that is an exploded perspective view of a composite wood and bamboo stick 10 according to a preferred embodiment of the present invention. As shown, the composite stick 10 includes a core rod 20 and a plurality of surface covers 30 firmly attached to and around outer sides of the core rod 20. The core rod 20 may be selected from the group consisting of a general wood material, a plywood material, and a composite wood material. The surface covers 30 may be selected from the group consisting of a general bamboo material, a bamboo plywood material, and a composite bamboo material. In the composite wood and bamboo stick of the present invention, a volume ratio of the surface covers 30 to the complete composite stick 10 is smaller than a volume ratio of the core rod 20 to the complete composite stick 10.

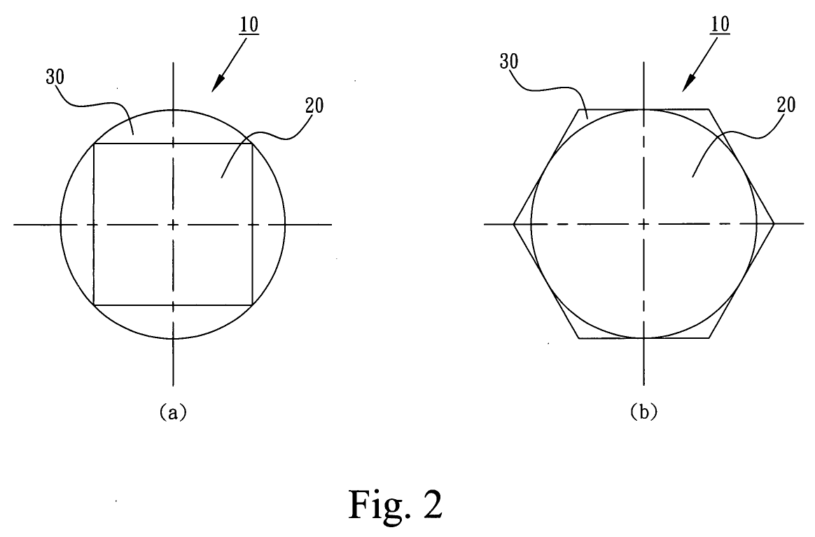

Please refer to FIG. 2. The composite wood and bamboo stick 10 of the present invention may have different cross sections, including a round section as the preferred embodiment shown in FIGS. 1 and 2a, a polygonal section as shown in FIG. 2b, a square section (not shown), an oblong section (not shown), or any other geometrical shapes that are comfortable for holding with hands. The core rod 20 and the surface covers 30 may be differently combined to give the composite stick 10 a special shape, such as that of a baseball bat.

Please refer to FIGS. 1 and 2 at the same time. The surface covers 30 may be attached to and around outer sides of the core rod 20 in different ways, such as pressing with a press so as to apply a force on the surface covers 30 and the core rod 20 and thereby firmly fix the surface covers 30 to the outer sides of the core rod 20. To ensure tight and stable attachment of the surface covers 30 to the core rod 20, a bonding agent may be further applied to contact surfaces between the surface covers 30 and the core rod 20.

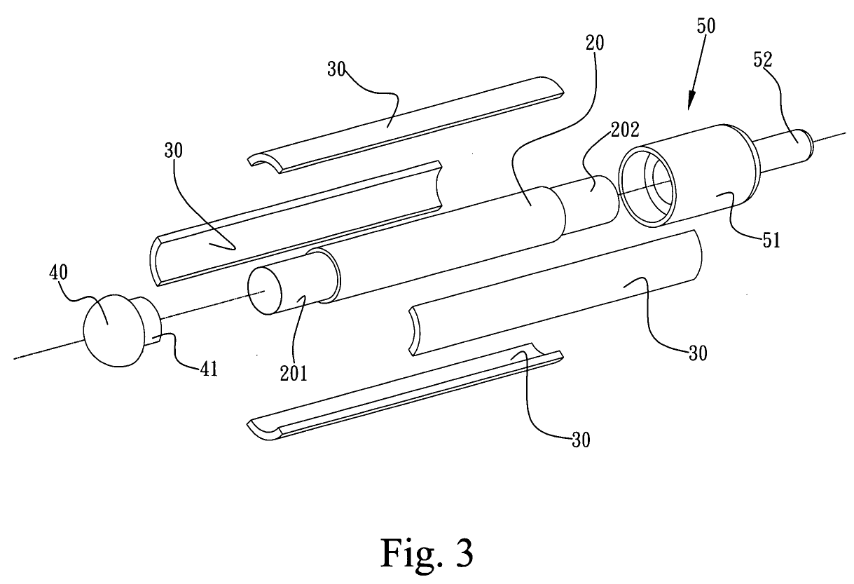

FIG. 3 is an exploded perspective view showing another embodiment of the composite wood and bamboo stick 10. As shown, in the second embodiment, the core rod 20 is formed at an end with a first joint 201, and at another opposite end with a second joint 202. Both of the first and the second joint 201, 202 are diametrically smaller than the core rod 20.

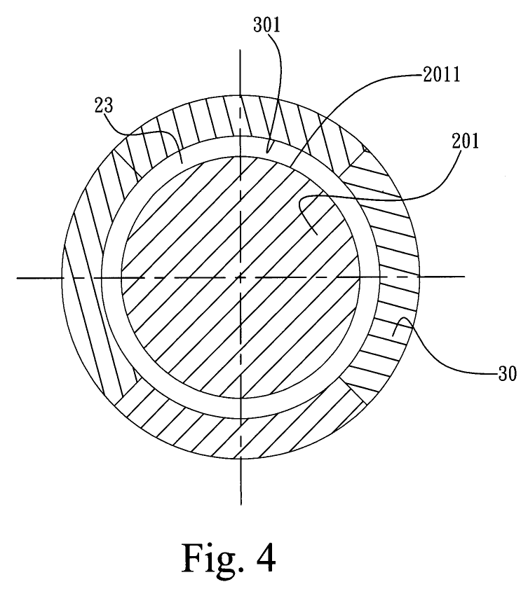

FIG. 4 is an assembled radial section of the composite wood and bamboo stick of FIG. 3. As shown, an annular retaining space 23 is formed on the composite stick 10 between an outer circumferential surface 2011 of the first joint 201 and inner surfaces 301 of the surface covers 30 attached to and around the core rod 20.

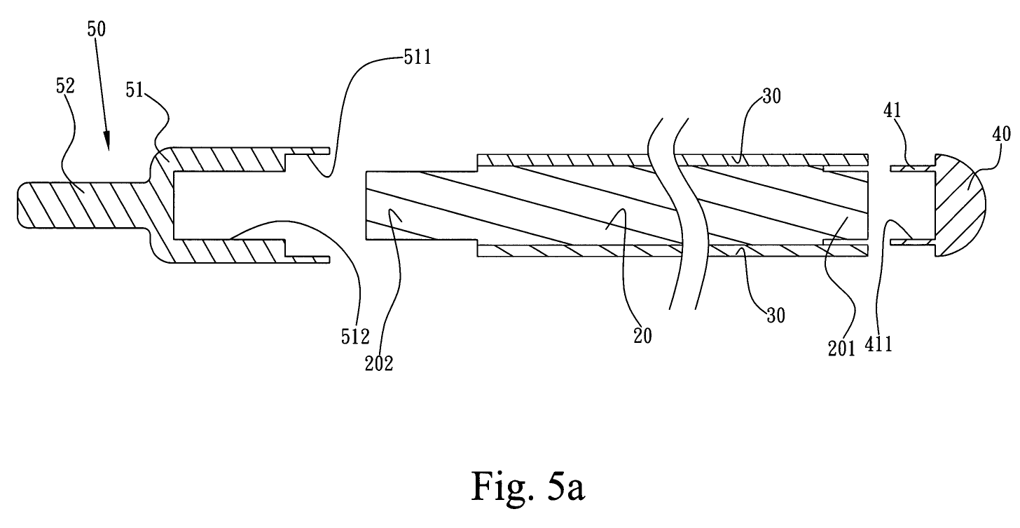

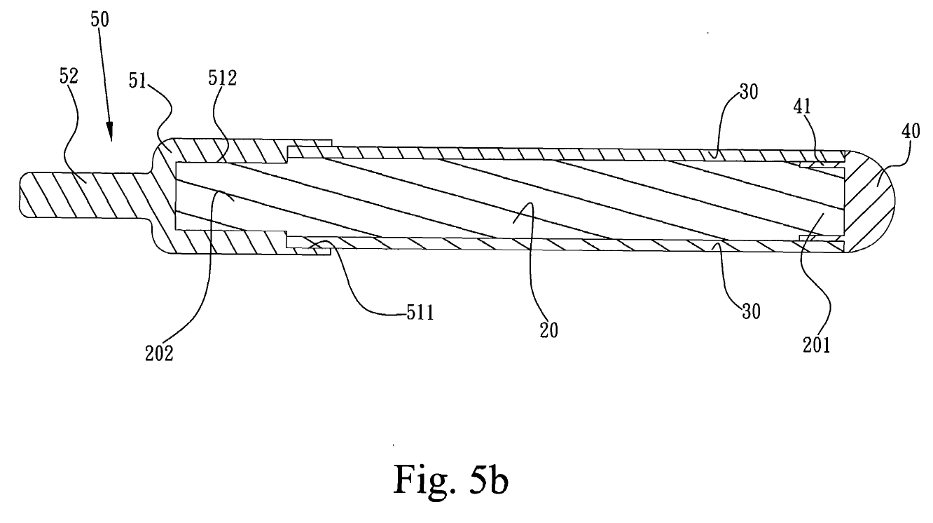

FIGS. 5a and 5b are exploded and assembled longitudinally sectional views, respectively, of the composite stick of FIG. 3. Please refer to FIGS. 3, 5a, and 5b at the same time. An end cap 40 is assembled to the annular retaining space 23 around the first joint 201 of the core rod 20. The end cap 40 includes a substantially semispherical top and an annular ring portion 41 axially extended from an inner side of the semispherical top by a predetermined length. The annular ring portion 41 has a wall thickness and length respectively corresponding to a width and depth of the annular retaining space 23, and internally defines a recess 411 dimensionally corresponding to the first joint 201, such that the annular ring portion 41 of the end cap 40 may be tightly fitted in the annular retaining space 23 and around the first joint 201 to thereby connect the end cap 40 to an end of the composite stick 10.

A linking head 50 is assembled to the second joint 202 of the core rod 20 by way of tight fit. The linking head 50 includes a female connector 51 and a male connector 52 facing toward two different directions. The female connector 51 defines a first bore 511 and a second bore 512 located behind and smaller than the first bore 511. The first bore 511 is sized for tightly fitting around an outer peripheral surface of the composite stick 10. The second bore 512 is communicable with the first bore 511, and is diametrically and lengthwise sized corresponding to the second joint 202 for tightly fitting around a full length of the second joint 202. With the second joint 202 tightly received in the second bore 512 and a length of the composite stick 10 adjacent to the second joint 202 tightly received in the first bore 511, the linking head 50 is connected to the other end of the composite stick 10 opposite to the end cap 40.

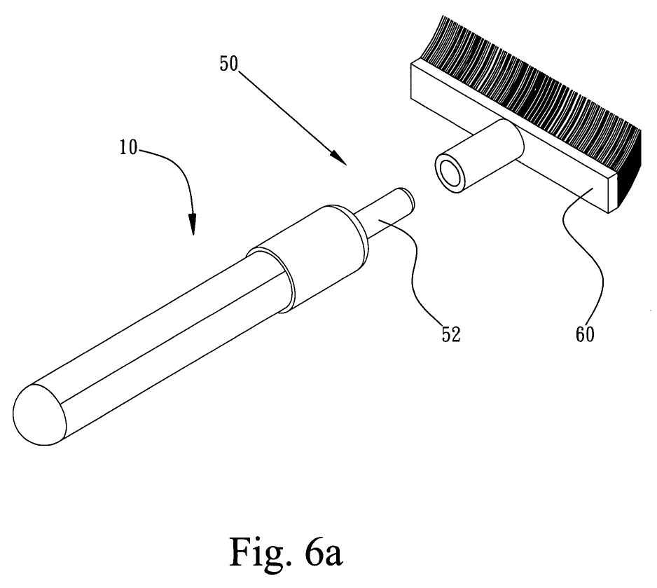

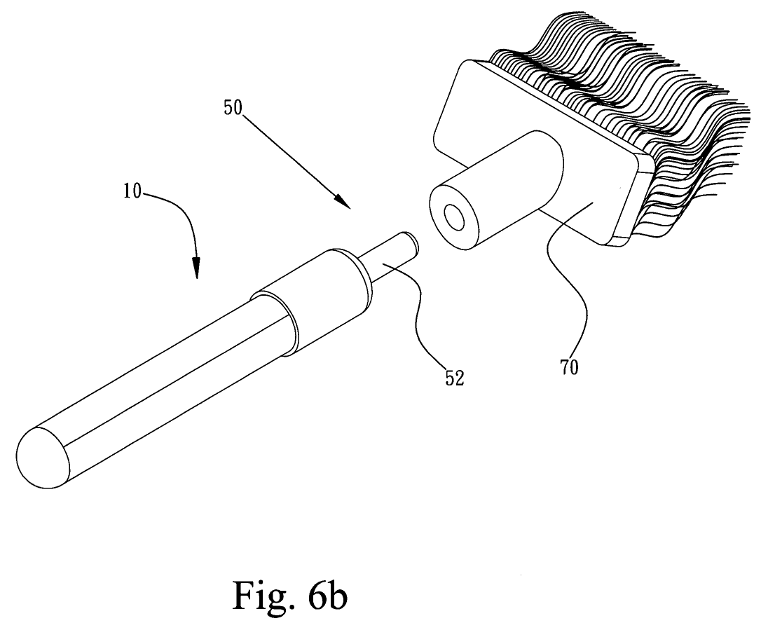

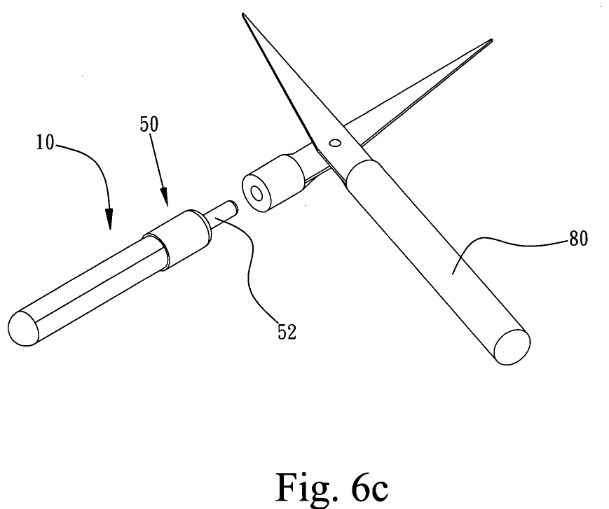

The composite wood and bamboo stick 10 according to the preferred embodiment of the present invention as shown in FIG. 1 may be directly used in cleaning and/or gardening tools as a broomstick, a mop handle, or handles for grass shears (not shown). Alternatively, the composite wood and bamboo stick 10 may be provided at two ends with the end cap 40 and the linking head 50 as the second embodiment shown in FIG. 3, and then conveniently connected at the male connector 52 to a broom head 60, a mop head 70, or a pair of grass shears 80, as shown in FIGS. 6a, 6b, and 6c, respectively. The male connector 52 may be further provided on an outer surface thereof with screw threads or retaining protrusions to ensure firm and stable connection of the composite stick 10 to different cleaning and/or gardening tools.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A composite wood and bamboo stick, comprising a core rod and a plurality of surface covers; and the surface covers being firmly attached to and around outer sides of the core rod to thereby form a complete stick.

2. The composite wood and bamboo stick as claimed in claim 1, wherein the core rod is selected from the group consisting of a general wood material, a plywood material, and a composite wood material.

3. The composite wood and bamboo stick as claimed in claim 1, wherein the surface covers are selected from the group consisting of a general bamboo material, a bamboo plywood material, and a composite bamboo material.

4. The composite wood and bamboo stick as claimed in claim 1, wherein the surface covers are pressed against and thereby fixedly attached to the outer sides of the core rod using a press.

5. The composite wood and bamboo stick as claimed in claim 1, wherein a volume ratio of the surface covers to the complete composite stick is smaller than a volume ratio of the core rod to the complete composite stick.

6. The composite wood and bamboo stick as claimed in claim 1, wherein the core rod is formed at an end with a first joint and at another opposite end with a second joint, and an annular retaining space is formed between the first joint and the surface covers.

7. The composite wood and bamboo stick as claimed in claim 6, further comprising a linking head and an end cap; the linking head being formed at two opposite ends with a male connector and a female connector, and the female connector being tightly fitted around the second joint; and the end cap including an annular ring portion axially protruded from an inner side of the end cap by a predetermined length for engaging with the annular retaining space.

8. The composite wood and bamboo stick as claimed in claim 6, wherein the first joint and the second joint are diametrically smaller than the core rod.

9. The composite wood and bamboo stick as claimed in claim 7, wherein the end cap has a substantially semispherical top.

10. The composite wood and bamboo stick as claimed in claim 6, wherein the male connector of the linking head is adapted to connect to different cleaning and gardening tools.

11. The composite wood and bamboo stick as claimed in claim 10, wherein the male connector is externally provided with screw threads.

12. The composite wood and bamboo stick as claimed in claim 10, wherein the male connector is externally provided with retaining protrusions.
